(19) United States
(12) Patent Application Publication
(10) Pub. No.: US 2017/0132369 A1
(43) Pub. Date: May 11, 2017

(54) GENETIC BASED HEALTH MANAGEMENT APPARATUS AND METHODS

(71) Applicant: Pathway Genomics Corporation, San Diego, CA (US)

(72) Inventors: Michael Nova, Del Mar, CA (US); Andria Del Tredici, San Diego, CA (US); Aditi Chawla, San Diego, CA (US); Victoria Magnuson, San Diego, CA (US)

(21) Appl. No.: 15/163,522

(22) Filed: May 24, 2016

Related U.S. Application Data
(63) Continuation of application No. 12/804,363, filed on Jul. 19, 2010, now abandoned.

(51) Int. Cl. G06F 19/00; H04L 29/08

(52) U.S. Cl. CPC G06F 19/322; G06F 19/3481; G06F 19/3475; G06F 19/3431; H04L 67/02

(57) ABSTRACT

Apparatus and methods are devised and provided to receive genetic material from a human test subject and further to characterize that genetic material into an electronic representation of a genome. In particular, with respect to many genetic features which relate to diet, nutrition and exercise with a view to weight control. Based upon the presence of certain genetic features, genetic markers or polymorphisms, a rules based logic path is executed to arrive at a action plan set of recommendations. These recommendations relate to lifestyle actions which may be taken up by a person and these actions thus relate to that person's particular genetic composition. These apparatus and methods produce an easy-to-consume visual presentation describing genetic based traits and conditions, the personal status of a test subject as it relates to these genetic dependent traits and conditions, and possible lifestyle actions which may be performed by the user.

### BACKGROUND OF THE INVENTION

Field

The following invention disclosure is generally concerned with genetic health management systems and more specifically concerned with automated systems for providing genome specific action plans for health management as it relates to diet, nutrition and exercise.

Prior Art

The practice of medicine is generally an inexact science where every case includes a complex dependence upon a great plurality of variables. The path to diagnosis often includes a generous application of “fuzzy logic”. To the extent that health management may be made discrete, practitioners have largely failed. Instead, at all levels various underlying circumstances and conditions lead to wildly different conclusions. For as many practitioners, there are ways to analyze data and reach a different conclusion.

However, recent advances in genetic sciences and further the ready availability of genetics testing facility and technique has made conditions ripe for new systems which aid in health management.

Specifically, each day brings additional information from many advanced research teams which include correlations between health traits, disease, and conditions and a person specific genetic makeup or genome. Polymorphisms in the genetic code are sometimes responsible for metabolic performance including dietary, nutritional and exercise response.

Studies in genetics have suggested that persons having particular genetic compositions may improve their chances in avoiding disease such as obesity by taking certain lifestyle actions—i.e. those relating to diet, nutrition and exercise.

However, these studies are exceedingly complex and as such not readily usable by the general public. Further, even where such studies could be reduced to practical discrete terms, it has been heretofore quite expensive if not impossible to discover the details of one's own genetic makeup. Genetic testing has not been available to those physicians and patients who seek to improve health and more specifically those who seek solutions to weight management. Only those persons so highly motivated and educated could read genetic studies related to obesity, further examine their personal genetic profile for the presence of particular polymorphisms and determine a course of action based upon their personal genome.

It is therefore highly desirable to have a machine and system by which a human subject merely submit a DNA sample, and receives in return and easy-to-use visual recommendation package to provide suggestions regarding diet nutrition and exercise most suitable for a particular genetic composition.

Inventors et al. of Massachusetts have identified and patented a human gene relating to obesity. In part, their teaching discloses detection and response to a finding of this gene in a human genome as it relates to weight management. In addition, the invention relates to antibodies to the protein encoded by the discovered nucleic acids. U.S. Pat. No. 7,501,118 contains details.

Renowned genetics research company ‘Myriad’ has patented in addition to their famous breast cancer genes, a gene which relates to obesity and uses of same. Specifically, the invention relates to detection of this ‘obesity’ gene and use in diagnostics of predisposition to obesity and/or diabetes. In U.S. Pat. No. 7,314,713 published Jan. 1, 2008 details will be discovered.

A gene associated with regulation of energy balance is taught in patented invention of U.S. Pat. No. 7,306,920 by Zimmet et al. Filed Jun. 3, 2002 the patent also relates to obesity and diabetes. A protein associated with the modulation of obesity and diabetes and metabolic energy levels is encoded by the claimed gene. The disclosure describes uses of the gene and systems which might be responsive to the presence of same.

In U.S. Pat. No. 7,302,398 a health management system quantitatively evaluates health using comprehensive indexes of personal health conditions to optimize and advance a healthcare guidance. A predicted period of health life expectancy and related information are displayed by display means or printed out by printing means.

Another obesity gene is discovered, disclosed, described and patented in U.S. Pat. No. 6,998,472 by Robinson et al. The gene used in transgenic animals may induce obesity or infertility.

Rothschild et al, teach in U.S. Pat. No. 6,803,190 issued Oct. 12, 2004 a gene and use of the gene as genetic marker for fat content, weight gain, and feed consumption. The gene being associated with fat content may be useful in selection of animals for breeding.

A gene therapy for obesity invention is presented in U.S. Pat. No. 6,630,346. Inventor Morsy et al describe a gene therapy to treat obesity in animals. The gene delivered to animals encodes leptin or a leptin receptor.

Inventor Brower of California teaches a computerized reward system for encouraging participation in a health management program. U.S. Pat. No. 6,151,586 describes in detail a computer system to assist in health management. The system is distributed over a network or by remote users may interact with scripts provided by a server to effect a health management program.

In U.S. Pat. No. 5,941,837 a health management and exercise support device are presented. Inventors Amano et al. provide an analysis module which receives waveform information and body movement information and from analysis of these further provides notifications to interested users.

A system which provides therapy reports for health management is presented as U.S. Pat. No. 5,724,580. A comprehensive management and prognosis report is formed at a centralized data management center for a patient at a remote location. Data from the patient is processed at an analysis module and a report which depends therefrom is formed and transmitted to the user.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Michael Nova, Andrea Del Tredici, Aditi Chawla and Victoria Magnuson with an invention characterized as genetic based health management systems including both apparatus and methods.

It is a primary function of these systems to provide health management systems based upon genetic information. These apparatus and methods start with a genetic sample from a particular human subject and produce therefrom an output which includes suggestions for lifestyle behavior modifications—and in particular those which relate to diet, nutrition and exercise, among others.

An automated health management and fitness system is devised to receive DNA sample material from a particular patient or human test subject and provide a visual presentation including a lifestyle action plan in response thereto. DNA which is quite unique to an individual is scanned in view of various known polymorphisms which have been shown to relate to fitness weight gain/loss and metabolism processes which might affect general fitness and body mass.

In consideration of the presence of these weight and fitness related genetic markers, lifestyle conclusions are drawn in the form of an action plan presented as a visual presentation. A genetic analysis module is devised with at least one discrete logic flow path. This logic flow path receives as input, encoded information which specify whether or not any particular genetic marker is present in a patient's genome. These genetic markers are expressed as input which drive conditionals of the logic flow path to lead to any of a plurality of action plans which may be arranged within action plan groups arranged by category. Behavior categories such as diet; exercise; drug therapy; lifestyle; and genetic therapy may be included. Depending upon logic branching as dictated by execution of conditionals which depend upon various weight/fitness related genetic markers, the system arrives at behavior recommendations which are quite particularly suitable for the subject patient. In view of a patient's particular genetic signature, a recommendation diet plan, exercise plan, drug therapy, lifestyle, and genetic therapy may be recommended.

Since a person's genetic profile is complete and unchanging throughout one's life, these systems additionally work well with children. Early intervention may be effective as lifestyle habits formed by young people can be carried throughout a lifetime. As such, particular value may be realized where a certain child's genetic profile might suggest preferable diets or other lifestyle behaviors.

The invention thus stands in contrast to methods and devices known previously.

### Objectives of the Invention

It is a primary object of the invention to provide new genetic based health management systems.

It is an object of the invention to provide systems for managing weight gain/loss based upon predicted metabolic response based upon genetic clues.

It is a further object to provide automated, easy-to-use, personal health management systems based upon discrete algorithms.

It is an object of the invention to eliminate ‘fuzzy logic’ and variability in results in health management systems based upon genetics by way of multiple discrete logic paths which can be executed by a machine.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a block diagram of a system characterized as a most general version of the invention;

FIG. 2 is an illustrative example of a visual presentation output of these systems;

FIG. 3 is a second example visual presentation of these systems;

FIG. 4 is a block diagram illustrating one example analysis scheme;

FIG. 5 is a further detailed example illustrating how one analysis in agreement with these teachings may be performed; and

FIG. 6 illustrates how various logic flow paths may be executed to lead to various resulting recommendations.

### PREFERRED EMBODIMENTS OF THE INVENTION

In accordance with each of preferred embodiments of the invention, automated health management systems are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

These health management systems which include both apparatus and processes are formed of four major component parts. A genetic scanner processes genetic material to yield an electronic signal by way of optical processes to characterize a person's genome. A rules library is comprised of discrete logic functions having inputs relating to features of a genetic profile and outputs which relate to action plans. The library is arranged as a computer readable storage medium which hosts logic code stored therein. The library is updateable whereby newly published research may be reduced to logic algorithms and added to the library where it may be executed in these methods. An analysis module receives genetic datasets from the scanner and further receives logic functions from the library. The analysis module processes these together to produce action plan recommendations which are passed to a fourth component: a reporter facility. The reporter facility takes action items, action plans, genetic data, and stored information relating to genetic traits and diseases and combines these to form visual presentations. These visual presentations may be encoded as digital files such as HTML files or PDF files. These files then are amenable for transmitted into a communications network for appropriate distribution.

These major four components operate together to provide users easy and ready access to enormous bodies of research science, in a simple and user-friendly manner. Even unsophisticated users can benefit greatly from very advanced genetic testing systems and complex body of science by merely submitting a saliva sample and receiving in return highly user specific report and action plan useful for health management.

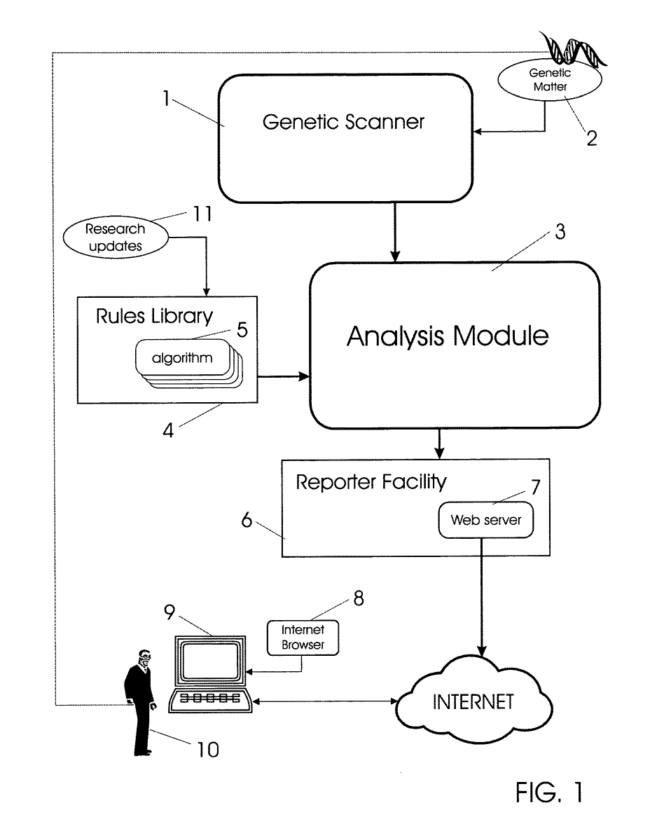

One most general version of an apparatus in accordance with this teaching is depicted in FIG. 1, a block diagram of major elements and the relationships and couplings therebetween. A genetic scanner 1 receives genetic matter 2 therein and operates on this received genetic matter to produce a physical signal which represents a person's genome which includes. The genetic scanner is communicatively coupled to an analysis module 3 whereby an electronic signal which represents a single human test subject's genome may be passed thereto. A rules library 4 comprising a plurality of discrete logic functions or algorithms 5 embodied as program code, code which is stored in a computer readable medium, is similarly communicatively coupled to the analysis module. These algorithms include parametric inputs which depend upon features of the genome as expressed by the signal from the genetic scanner. Upon receipt of such parametric input, these algorithms may be executed to produce results and outputs which relate to lifestyle actions. For example, a person may have a “sweet tooth” gene which is associated with the vulnerability to sweet foods. This gene sometimes and herein called: ‘SLC2A2-RS5400’ is an input for one rule of the rules library. Where the C/T genotype is found, a diet lifestyle recommendation or action plan is given as an output of the algorithm. An action item of this action plan may include suggestion to substitute healthy sweets such as fruit in place of chocolate, candy, soda, etc. While this very simplistic example relates to a single parametric input and single output, most useful logic rules used in these systems depend on a plurality of genes and may have a plurality of outputs that are significantly more complex than those which are described here. In response to execution of the algorithm, data including lifestyle suggestions, genotype, gene ID, scientific strength values, among others is passed to a reporter facility 6. The reporter facility assembles this data together to form a visual presentation. A visual presentation may include text and graphics in a layout and form which contribute to an easy-to-understand arrangement which may be consumed by unsophisticated users merely by observation.

In one most important version, a reporter facility includes a Web server 7 computing system and apparatus coupled to the Internet. A Web server may be used to assemble the component parts of the visual presentation as a webpage of interactive Web controls. Interactive Web controls are responsive to actions and events which occur on a web browser 8 deployed at a user workstation 9 which is presenting the visual presentation via the webpage. A user 10 being the same person who provided the DNA sample may receive by viewing, lifestyle recommendations which are highly specific to his particular genetic makeup.

While it is proposed that DNA matter is used as a starting point, it is also anticipated that RNA and products of DNA and RNA may similarly be used as an input from which a personal genetic signature may be derived. In some versions of this invention, the input is matter from which can be read a genetic sequence.

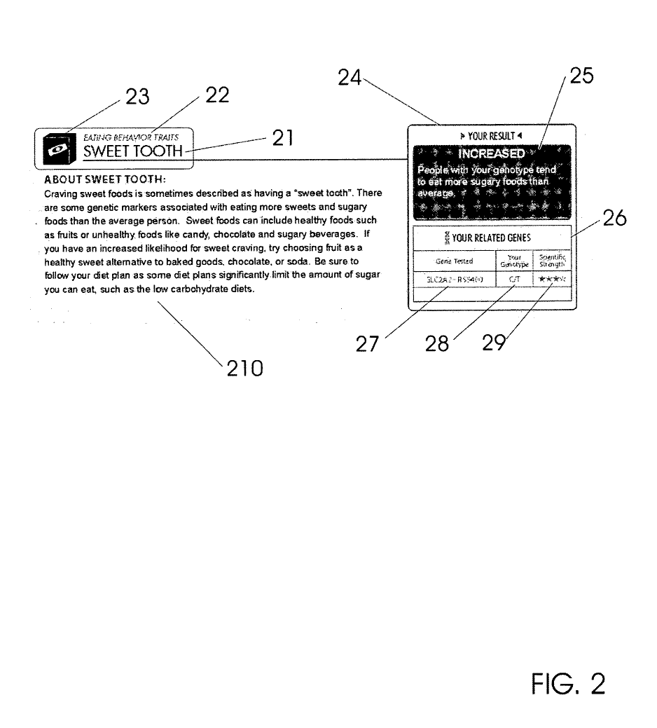

FIG. 2 illustrates one important portion of a visual presentation of these systems, the visual presentation produced by a reporter facility in response to execution of at least one stored algorithm in view of genetic an electronic signal received from a genetics scanner at an analysis module. In particular, a display field includes a spatial region for presentation of a trait name and trait category designator including a graphical reference. A second region contains an array presentation of risk level and a gene table. A third area contains a general description of the traits and its relationships with certain behaviors which can affect the trait response.

Specifically, a trait ‘name’ 21 e.g. “sweet tooth” may be expressed as a large font type title of this portion of the presentation. A category 22 e.g. “eating behavior traits” in which the trait might be classified maybe presented in conjunction with the title. A graphical representation 23 of the category provides an effective association means for more visual users who might be responsive to graphical cues. A very important portion of these visual presentations includes an array 24 having therein a relative genetic risk evaluation 25, and a gene table 26. The gene table may include a gene ID or designation 27, a genotype specification 28, and a graphical indication of scientific strength 29. Finally, a detailed description of the trait any precautions or actions which might be taken by a consumer of the information is provided as a test block 210.

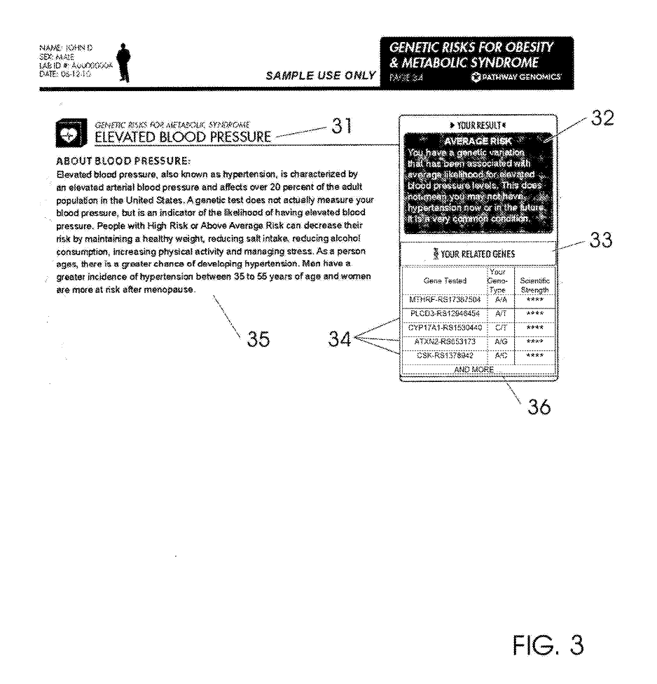

In some versions of the visual presentations provided by these reporter facilities, a genetic related trait may depend upon a great plurality of distinct gene variations. FIG. 3 illustrates a more complex story where the trait or disease of interest is characterized as ‘blood pressure’. A visual presentation includes name indicia 31 e.g. “Elevated Blood Pressure” alongside text and graphic indicia for the category, e.g. “metabolic syndrome” of this type. A description relating to specific genetic risk of the person for which the report is generated 32 is provided in response to finding various genetic markers in the genome of the particular person. A careful observer will note this field will be different for each genotype. A gene table 33 may include many distinct genes 34, the associated genotype for the person tested, and the various indicators for scientific strength associated with each of these genes. An overall brief description 35 of the trait and possible lifestyle recommendations which might improve or degrade the condition is presented.

FIG. 3 additionally illustrates one important tool of advanced versions of the systems. Where these visual presentations are embodied as webpages, these visual presentations may include interactive Web controls which are responsive to user actions. For example, hyperlink 36 may include a URL to another source having additional related information. As such some of the visual presentations provided by the systems are interactive and are embodied as HTML encoded webpages with Web controls and/or script which permits the presentation to be responsive to user actions.

In alternative versions the visual presentation is configured as a static document without interactive elements. Some versions of a static visual presentation are suitable for printing on a paper medium. For example these visual presentations may be encoded in a portable document format PDF electronic file which is cooperative with conventional printing systems.

In most important versions, an analysis module comprising several distinct and discrete logic flow paths. Based upon a preliminary determination relating to risk and in most cases to genetic risk specifically, either of several available logic flow paths are chosen. A genetic profile processed by one logic flow path could produce a different output than the same genetic profile processed in accordance with a second logic flow path. To make a determination of risk, a risk assessment module considers input information, sometimes from several sources, and categorizes risk in one of several prescribed discrete levels. For example, as a preliminary step a risk assessment module may categorize risk in either ‘low’,'medium', or ‘high’. Thereafter, the analysis module processes received genome information with a logic flow path specifically designed for that particular risk level. While one important scheme categorizes risk as ‘low’, ‘medium’, and ‘high’ —another useful scheme may include five distinct risk levels. For simplicity of illustration, examples are drawn to a system having three distinct categories of risk ‘low’ ‘medium’ and ‘high’. One will appreciate that systems in which risk is discretized to a greater resolution are considered included versions of the same concept.

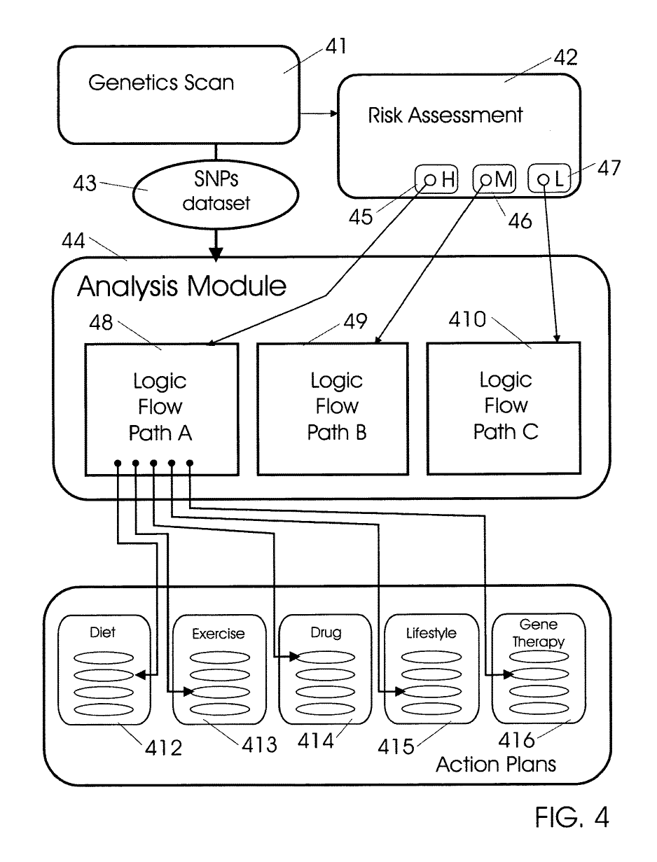

With reference to FIG. 4, one will appreciate a first important version where output from a genetic scan 41 is passed to a risk assessment model 42. In addition, a SNP dataset encoded as an electronic signal is passed to the analysis module 44. The risk assessment module selects either of: ‘high’ 45; ‘medium’ 46; or ‘low’ 47 risk levels and conveys such determination to the analysis module which includes several independently executable logic flow paths: logic flow path ‘A’ 48; logic flow path ‘B’ 49; and logic flow path ‘C’ 410. These logic flow paths each receive their logic functions from the coupled rule library.

The genetics marker dataset received from the genetic scanner is used to drive parameter inputs of the specific logic flow path which corresponds to the assessed risk level. If a ‘high’ risk is determined with respect to a disease or condition or trait, the genetic dataset is processed in accordance with logic flow path ‘A’ to arrive at a set of action plan 411 suggestions which may relate to: diet 412; nutrition; exercise 413; drug therapy 414; lifestyle behaviors 415 or gene therapies 416, among others.

Risk assessment may be made based solely upon genetic information received from a genetics test. However, preferred versions include a risk assessment module which is responsive to additional inputs which might reflect risk of disease or trait of interest. For example, metabolic testing; family history; etc. these inputs may also be used in preliminary determinations of risk.

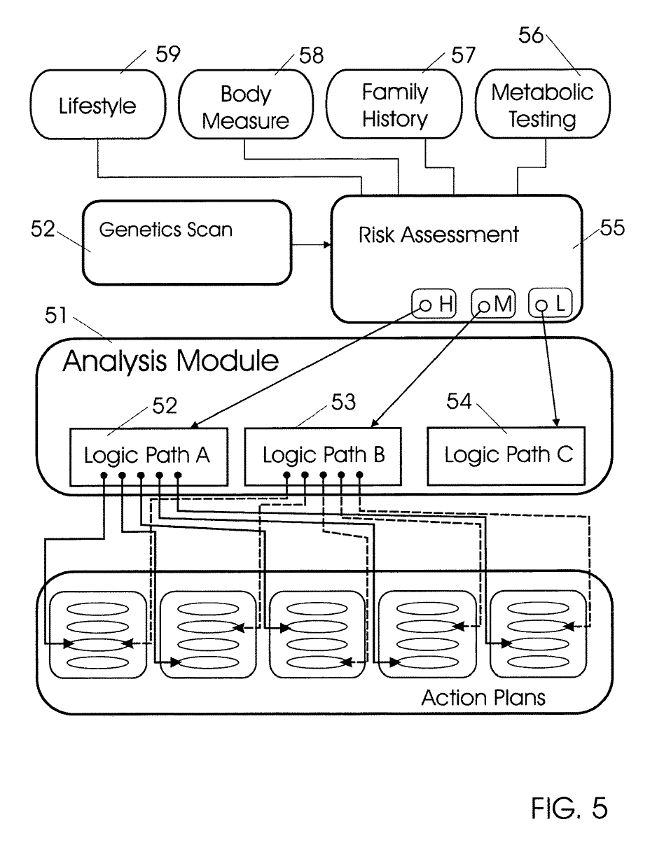

This is more readily understood in consideration of the block diagram of a FIG. 5. An analysis module 51 having a plurality of discrete independent logic flow paths: logic flow path ‘A’ 52; logic flow path ‘B’ 53; and logic flow path ‘C’ 54, are coupled to a risk assessment module 55. This risk assessment module receives input electronic signals encoded with information related to metabolic testing 56, family history 57, biometrics factors 58, and lifestyle 59. For one human test subject, a risk assessment may yield a ‘high’ value. For a different person the assessment may yield a ‘medium’ risk value. For the person determined to have a high risk for a particular disease, his genetic profile is processed in accordance with logic flow path ‘A’. For a second person where a risk for the same disease is determined to be ‘medium’, her genetic profile is processed in accordance with logic flow path ‘B’. In both cases, the outputs lead to suggestions of actions which can be taken to mitigate exposure to difficulties associated with the disease.

It is very illustrative to consider a special case. In certain versions of these systems, it is quite possible that any two persons have an identical set of genetic markers. While their entire genetic code is of course unique, a finite set of markers considered for these systems may include between 2 and 3 hundred distinct polymorphisms; or even many more than that in some advanced versions. Therefore, it is likely that any two persons share an identical set of these hundreds of genetic markers under consideration. However, due to various values passed into the risk assessment module from lifestyle surveys, bodymetric measurement, family history records, metabolic testing, et cetera, the risk assessment for these two people may be different. Therefore, each of their genetic profiles (identical) will be processed along different flow logic paths to arrive at different action plans. Recommended actions from logic flow path ‘B’ (shown in dotted lines) are different than those of logic flow plan ‘A’ (shown in solid lines) even where the SNPs dataset is the same.

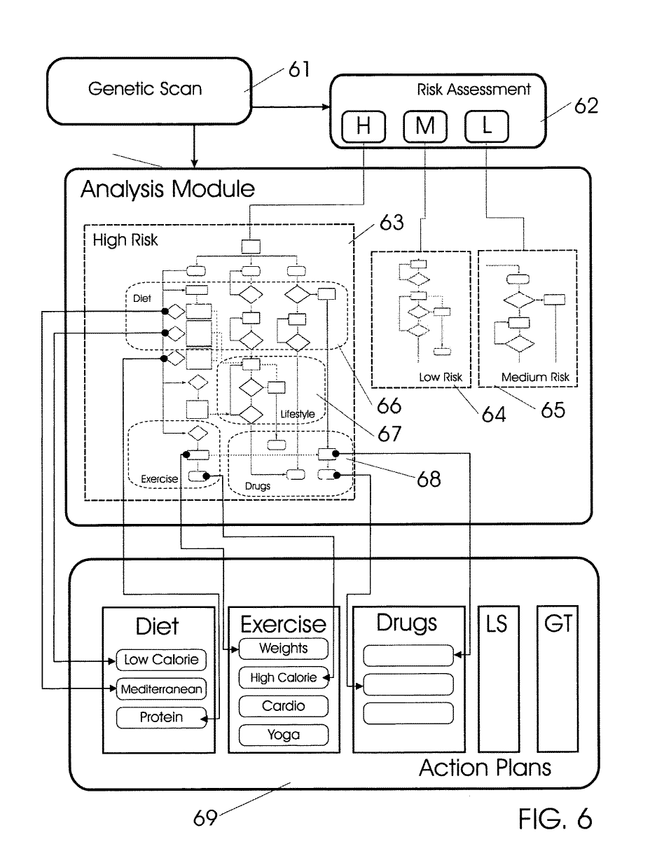

Each distinct logic flow path receives a dataset of genetic markers and processes these inputs via a set of rule-based algorithms to produce action recommendations which relate to diet; exercise; drug therapy; lifestyle; and gene therapy, in example. The execution of any particular algorithm they produce a result of discrete action item. One or more algorithms may be associated with a single action group e.g. ‘diet’. Each algorithm has at least one input which is coupled to a genetic profile expressed as a collection of polymorphisms or genetic markers. Execution of a single logic flow path may produce action items in all groups or may produce action items in a single group. With reference to FIG. 6 genetic testing 61 produces an electronic signal encoded with information to indicate the presence or absence of a plurality of genetic markers. A risk assessment 62 is made to determine a risk level and a corresponding logic flow path. Where ‘high’ risk is determined, logic flow path 63 associated therewith ‘high’ risk is executed in view of the SNPs of the genetic profile. Logic flow paths for ‘low’ risk 64 and ‘medium’ risk 65 are unused in this example. A set of rules associated with ‘diet’ 66 are executed as part of the high-risk logic flow path to produce various action recommendations related to diet. Another set of rules embodied as computer coded logic 67 relating to ‘lifestyle’ may also be executed. Rules 68 relating to drug therapy/use may produce recommendations which dictate aspects of a program of drug therapy. In this way, a complete action plan is put forth which depends primarily upon genetic markers found in an individual's specific genome.

It should be appreciated that the number of SNPs or genetic marker used in these systems may be quite large. In addition, new markers may be added to the system as they become known. New research may yield findings of genetic markers and their relationships with fitness—and those studies may be reduced to discrete algorithms in accordance with the teachings described herein. While it is fully anticipated that new important genetic markers will come with new research, and that these systems will function equally as well or better once they become known, it is nevertheless useful to present a list of genetic markers which are presently known to relate to fitness.

In a most general specification, apparatus taught herein may be described as follows. A device for managing ones personal lifestyle based upon their particular genome and a body of known research studies having been reduced to discrete algorithms is formed of the following primary components including: a genetic scanner, a library of discrete algorithms based upon research studies, a computing analysis module and a reporter facility.

The genetic scanner operates to receive genetic matter from a patient or person having interest in maintaining a healthy lifestyle. Received genetic matter is strictly kept isolated with respect to DNA from foreign sources. The DNA is amplified and examined for presence of prescribed known polymorphisms. The genetic scanner provides an output signal to an analysis module where that output signal has been associated with a unique identifying code or index whereby association with the human donor is maintained.

At least one algorithm from a set of algorithms stored in a rules library is passed to the analysis module for execution against a signal representing a person's genome. Algorithms stored in the rules library include inputs parameters which relate to the presence of known polymorphisms in a genome. Algorithms have outputs which suggest behavioral actions related to diet, nutrition and exercise for example.

The analysis module receives from the rules library via electronic communication, these discrete algorithms to be executed in view of electronic signals similarly received from the genetics scanner. The analysis module couples the particular polymorphisms present in the genome to the appropriate inputs of various rule algorithms. Further, the analysis module executes those algorithms to produce an output which may be conveyed to the reporter facility.

The reporter facility in communication with the analysis module receives algorithm outputs and uses those to drive a system to produce a visual representation of action plans relating to diet, nutrition and exercise. More specifically, these algorithm outputs are used to build visual presentations which include text and graphics to represent actions which may be consumed by a user via observation.

In some best versions, a reporter facility is embodied as a webserver computing system coupled to the internet. The webserver is arranged to transmit over public networks these visual presentations which may be encoded via HTML as webpages and these web pages may further include interactive graphical elements. Upon appropriate authorization, these reporter facility webservers are arranged to transmit visual presentations encoded as web pages to remote client users.

Alternative versions which do not require any interactive elements may be embodied as static PDF electronic files which encode a print document suitable for printing on a paper medium in the style of a multipage report. Such electronic file may be transmitted to a remote client workstation via the internet.

In some important versions, the rules library is arranged and provided as an updatable system which can receive new algorithms therein for future execution as part of normal operation of the device. As new scientific research is developed which brings to light new correlations between genetic features and health traits, these studies can sometimes be reduced to and expressed as discrete algorithms. Where that is possible, these algorithms may be inserted into the library to join the set of algorithms already there and may be executed in similar fashion when a particular genome is considered.

Preferred systems include an authentication system which regulates access to both genetic data and any output produced by the reporter facility. Data and information is restricted to those having authorization. For example, only a person who provides genetic matter to the input of the genetic scanner—is afforded access to the system by way of a password for example.

While these systems are clearly embodied as a sophisticated machine and apparatus by which genetic information and scientific research are input and lifestyle suggestion relating to diet, nutrition and exercise are output, the invention further includes methods. Methods of providing behavioral modification recommendations are part of the entire teaching.

Particularly, methods of providing behavioral modification recommendations which include the following steps.

In a first step, a single human subject provides genetic material including DNA and same is received at a genetics scanning apparatus. A most preferred and simple way to receive DNA is via a saliva sample. The DNA so received is amplified in convention processes to increase the quantity of DNA and some specific portions thereof to be used in further processes. Amplified DNA is reacted with a gene chip genetic probe for example to determine the presence of certain important polymorphisms which might be present in a human DNA sample.

An electronic signal which represents the genome of the subject DNA donor is formed and conveyed to an analysis module. Parametric inputs of prescribed stored algorithms are coupled to the signal which represents the genome whereby the algorithm may be executed to produce an output which represents some lifestyle or behavioral action. A visual presentation is arranged in accordance with outputs from the algorithm where elements of the visual presentation depend upon output values provided by the analysis module.

In addition, these methods are further characterized or defined by additional steps as further definition of those steps already presented as follows. Behavioral actions are generally characterized as actions which a subject under test may perform or take, those actions being related to diet, nutrition and/or exercise. Some most important versions of these inventions include methods whereby the visual presentation is embodied as a webpage portion of a website—the webpage being encoded by HTML and having interactive web control elements. The visual presentation is an arrangement of text and graphical elements spatially distributed to form an easy-to-view, easy-to-understand representation of an action plan related to a genetic trait or health characteristic.

In some important alternative versions, a visual presentation is embodied as a static presentation (e.g. without interactive components) encoded as in a portable document format—PDF electronic file.

In still other versions, a visual presentation is delivered as a printed document comprising at least one sheet of paper or similar matter with printed indicia thereon.

In some methods, a step is provided in which a rules library is updated by having added thereto newly developed rules based on recent genetic studies which relate to diet, nutrition and exercise.

These methods sometimes include algorithms which depend upon a prescribed group of genetic markers or polymorphisms.

Methods first presented herein this disclosure include those in which a step of arranging a visual presentation includes forming a graphical object including an array arrangement of: a genetic risk level and a gene table—the gene table including fields for: a descriptor or handle of the gene tested; determined genotype specific to the human under test; and a strength of correlation between the gene and presentation of the trait or characteristic being described.

In some versions, a step includes providing a visual presentation which comprises a text description of health traits or conditions and behavioral actions which relate thereto.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how an automated genetics based health management system may be used to provide lifestyle choices to a user based upon a personal genetic profile. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) Apparatus for lifestyle management comprising:
a genetic scanner;
a rules library;
an analysis module; and
a reporter facility;
said genetic scanner is arranged to receive genetic samples from human subjects, to amplify DNA therein, to test for the presence or absence of genetic markers therein, and to provide an output signal to said analysis module indicative of the presence or absence of said genetic markers,
said rules library is comprised of a plurality of genetic related relationships reduced to discrete algorithms, each having at least one input related to genetic polymorphism and an output related to either diet, exercise or nutrition,
said analysis module is communicatively coupled to said rules library whereby it may receive there from discrete executable algorithms, further communicatively coupled to said genetic scanner whereby it may receive therefrom signals associated with a single human subject, the signal indicative of the presence or absence of specific genetic markers, said analysis model being arranged to couple appropriate inputs to corresponding genetic markers indicators and to execute those algorithms to produce outputs related to diet, exercise or nutrition and to pass those outputs to said reporter facility,
said reporter facility being communicatively coupled to said genetic scanner and said analysis model to receive analysis model outputs related to diet, exercise, and nutrition, and to arrange those outputs into a visual presentation including graphical objects suitable for being consumed by human users via observation.

2) Apparatus of claim 1, said reporter facility is comprised of a computing system arranged as a Web server coupled to the Internet.

3) Apparatus of claim 2, said Web server is arranged to transmit visual presentations encoded as web pages to remote authorized clients.

4) Apparatus of claim 2, said Web server is arranged to transmit visual presentations encoded as PDF files suitable for printing at a remote client workstation.

5) Apparatus of claim 1, said rules library is comprised of computer executable code stored on a computer readable medium, the library being updatable whereby newly developed rules and functions may be added to the library whereby those newly developed rules may form the basis from which said visual presentations depend.

6) Apparatus of claim 1, said apparatus is further comprised of an authentication system, said authentication system is arranged to a sign and associate a unique identifier code and index with each output signal received from said genetic scanner whereby said output signal may always be associated precisely with one particular human subject.

7) Methods of providing behavioral modification recommendations comprising the steps:
receiving in isolation from a single human subject genetic matter including DNA;
amplifying said received DNA;
detecting for the presence or absence of a plurality of prescribed genetic markers in said amplified DNA;
forming an electronic signal expression of the presence or absence of the prescribed set of genetic markers;
coupling a plurality of stored algorithms each having at least one genetic marker related input to said electronic signal;
executing said algorithms to produce a result output whereby said result output relates to behavioral actions; and
arranging a visual presentation having text and graphical complement which depend upon said result outputs.

8) Methods of claim 7, said behavioral actions may be characterized as actions related to diet, exercise and nutrition.

9) Methods of claim 7, said arranging visual presentation is further characterized as providing an HTML encoded webpage comprised of a plurality of interactive Web control devices arrange spatially to form a visual representation of behavioral action suggestions.

10) Methods of claim 7, said arranging visual presentation is further characterized as providing an electronic file arranged in a PDF format comprising text and graphical complement arranged to express a visual representation of behavioral action suggestions.

11) Methods of claim 7, said arranging a visual presentation is further characterized as forming a printed report.

12) Methods of claim 7, further comprising a step of updating said rules library with newly developed algorithms in view of new scientific research which relates to genetic effects on diet exercise and nutrition.

13) Methods of claim 7, said prescribed set of genetic markers is comprised of those from the group which includes genetic markers having a correlation with excess weight.

14) Methods of claim 7, said arranging a visual presentation includes forming a graphical object in association with a health condition or trade, said graphical object includes an array arrangement of: risk level and gene table; said gene table including fields for: gene tested; determined genotype; strength of correlation.

15) Methods of claim 14, said visual presentation further comprises a text description of the health trait or condition and behavioral actions which relate thereto.
